(19) United States
(12) Patent Application Publication
(10) Pub. No.: US 2021/0239184 A1
(43) Pub. Date: Aug. 5, 2021

(54) BLOCK LOCK FOR ROUND STEEL CHAINS FOR MINING

(71) Applicant: SCHMIEDESTÜCK-VERTRIEB FEUERSTEIN GMBH, Hattingen (DE)

(72) Inventor: Till Stukenberg, Bochum (DE)

(73) Assignee: SCHMIEDESTÜCK-VERTRIEB FEUERSTEIN GMBH, Hattingen (DE)

(21) Appl. No.: 17/254,742

(22) PCT Filed: Jun. 24, 2019
(86) PCT No.: PCT/DE2019/100581

§ 371 Date: Dec. 21, 2020

(30) Foreign Application Priority Data
Jun. 22, 2018 (DE) 10 2018 115 129.2

(51) Int. Cl. F16G 15/06

(52) U.S. Cl. CPC F16G 15/06

(57) ABSTRACT

Block lock (100) for round steel chains, having two half elements (10) which are displaceable relative to one another for opening and closing the block lock (100) and which each have ends connected to one another via a longitudinal web (10.1), of which in each case one end has an insertion plug (11) with a width reduced in relation to the longitudinal web and with retaining webs (13.1, 13.2) integrally formed on both sides, wherein at least two parallel retaining webs (13.1, 13.2) are arranged above one another on each side, and of which in each case the other end has a receiving pocket (12) which serves to receive the insertion plug (11) and on the two lateral inner flanks of which there are in each case formed at least two retaining grooves (14.1, 14.2) above one another to form a toothing by receiving the retaining webs (13.1, 13.2). A central web (10.2) extends inwardly from at least one longitudinal web (10.1). The insertion plug (11) widens, as seen in side view, from the longitudinal web (10.1) towards its end, and the length of the retaining webs (13.1, 13.2) increases. At the same time, the receiving pocket (12), as seen in side view, narrows from the longitudinal web (10.1) to its end.

The invention relates to a block connecting link for round steel chains for mining, which has the features of the preamble of claim 1.

When mining, in order to transmit high tensile forces, for example in planing systems, chain connecting links are used in order to lengthen chains or to repair broken chains. It must be possible to separate the chain connecting links into two halves in order to attach them to existing chain links of a chain end. The chain connecting link is not only required to be able to reliably transmit the high tensile forces inside the chain strand, but also to provide a sufficient amount of strength in the event that the chain connecting link is not loaded along the longitudinal axis, but at an angle, or even transversely, thereto, as a result of an inclined position, for example on a deflection pulley. In addition, the geometry must be such that the adjacent chain elements can be securely received but also remain moveable. Lastly, the chain connecting link is intended to run inside the chain strand and can also be guided over deflection devices or other guide devices in this case without interlocking.

In the chain connecting links for use in mining, a differentiation is made between flat connecting links according to DIN 22258-1 and block connecting links according to DIN 22258-2. The flat connecting chain link is used in planing chains, whereas the block connecting link is predominately used in conveyor chains. The flat connecting chain link can run through the sprocket both horizontally and vertically. The block connecting link may only run vertically through the sprocket.

DE 203 07 184 U1 discloses a generic block connecting link that is designed such that the height measured transversely to the longitudinal extension of the chain strand is no greater than that of the adjacent chain links. Since two retaining grooves and two retaining ribs are provided in order to connect the half elements, force is reliably transmitted even when the block connecting link runs around a deflection wheel, for example, wherein forces that can be transmitted to the guide grooves and guide ribs by overlapping flanks occur obliquely to the longitudinal axis.

The disadvantage of the known block connecting link consists of the fact that it can only be mounted by a mounting direction that is oriented transversely to the longitudinal extension of the chain strand. For this purpose, the two chain ends first have to be freely held face to face. A half element of the block connecting link is inserted into each of the chain ends. The half elements are then moved with respect to one another such that the retaining ribs can be inserted into the associated retaining grooves. After the half elements have been assembled to form the chain connecting link and secured with respect to one another by a securing pin, the block connecting link still has to be pivoted by 90° out of the mounting position and into its use position such that it fits in the longitudinal extension of the chain strand. In light of the sizeable dimensions and the resultant masses of mining chains and the associated block connecting links, vertical mounting is not simple and cannot be carried out by one person on their own. The known block connecting link cannot be effectively mounted on chain pieces lying on a substrate. In addition, a continuous eye has to be formed in the block connecting link for both chain links, the length of which is substantially greater than twice the diameter of the chain links such that a clearance remains. Since the chain links interconnected by means of the known block connecting link are not separated by a middle rib, there is a risk of kinking, i.e. both chain links can be arranged next to one another on one side of the eye such that the block connecting link is not pulled in the longitudinal direction of the chain, but may jackknife.

The object of the present invention consists in improving a block connecting link of the type mentioned at the outset such that mounting is possible when the chain strand is horizontal and that two eyes separated from one another by a middle rib are also formed in the block connecting link once it has finished being put together, in each of which a chain link is guided.

This object is achieved by a block connecting link for round steel chains for mining that has the features of claim 1, which is predominantly characterized by a shorter closing path but simultaneously also provides a middle rib.

Use in mining is essential in as much as reference is therefore made to specific dimensions of the chain links to be connected, high masses of the half elements of the block connecting link and corresponding high forces for the mounting process. The block connecting link has to withstand these loads. Use of block connecting links formed according to the invention for other fields of application of similar dimensions, for example anchor cables, is not ruled out either.

In the half elements of the block connecting link according to the invention, multistage teeth are provided, as is known per se. These are formed in each case by two parallel retaining ribs and retaining grooves, which are arranged in the middle of the finished block connecting link at the level of the receptacles for the chain links. As a result, the flanks of the retaining grooves and retaining ribs remain largely unloaded provided that the chain is guided linearly, and only temporary loading of the flanks occurs at deflection points or in the event of chain misalignment that results for any other reasons.

An essential feature of the block connecting link according to the invention consists in the retaining ribs and retaining grooves being of different lengths and being arranged in receiving regions that are formed by insertion pins and receiving pockets. The insertion pin comprising the outwardly protruding retaining ribs has the longer side of the in the parting plane and tapers towards the outer edge of the block connecting link, towards the longitudinal rib, whereas the receiving pockets, in the side flanks of which the retaining grooves are formed, have the narrow side in the parting plane and widen outwards therefrom towards the longitudinal rib.

The receiving regions are preferably trapezoidal in cross section or when viewed from the side. When in the shape of a trapeze, the boundary edges are straight, which is simpler to process and adapt to one another later on than in the curved shapes that are, in principle, likewise conceivable. By means of this design of the connecting regions of the half elements, a mounting direction is formed which is not precisely perpendicular to the longitudinal axis, but is inclined with respect thereto at an angle of from approximately 60° to 85°.

Another feature consists in that the mounting process can be carried out in two ways. The half elements, including the end chain links, can be put together in said oblique mounting direction until they rest against one another before an axial thrust is finally carried out in the longitudinal direction, by means of which the positive fit between the half elements is produced.

According to another mounting variant using the same half elements, a plurality of steps are successively performed transversely to and along the longitudinal axis, as a result of which a stepped movement pattern is formed when viewed from the side. The second mounting variant, which the block connecting link according to the invention allows for, is advantageous in that a provisional positive fit is already achieved in an intermediate layer such that the half elements are no longer able to come apart as early as after the first sequence of one transverse and one longitudinal movement:
The stepped mounting process allows for mounting when the chain strand is horizontal, for example, without the chain ends having to be held up. For example, the bottom half element can be placed on the substrate for mounting purposes.
The end chain links of the chain portions to be connected to one another are each inserted into one of the half elements, wherein each inner flank on the half element preferably tapers off in the direction of the parting plane in the shape of a hook such that the chain link is interlockingly held there.
When assembling the half elements, the particular longer retaining rib only has to be freely pushed into the receiving pocket at first. Then, it can be inserted into the short retaining groove by means of a slight advancement movement in the longitudinal direction.
In the further course, the half elements are then once again pressed together, transversely to the longitudinal direction such that the long retaining rib that is closer to the parting plane is moved out of the short retaining groove up to the level of the adjacent long retaining groove.
Another advancement movement is finally carried out in the longitudinal direction, in which both retaining ribs are then inserted into the retaining grooves assigned thereto with regard to their length and reach their end position.

The mounting direction is therefore not necessarily linear, but can also be stepped, in which the two chain members in the last variant are already securely held by the intermediate step and the two half elements are interlockingly coupled to one another to such an extent that they can no longer be accidentally torn apart.

Despite the easier mounting process, the strength of the block connecting link is not impaired. The middle rib, which is preferably provided despite the short mounting path, prevents the halves from deflecting inwards under load, as a result of which the teeth are, in turn, relieved from additional strains caused by deflections. The middle rib of the block connecting link is preferably formed by two individual middle ribs, each of which extend inwards from the longitudinal ribs of the half elements, i.e. in the direction of the eyes to be formed. The end faces of the middle ribs lie face to face in the parting plane.

The middle rib can extend up to the central axis of the block connecting link in each case such that, after assembly, a gapless rib is provided. The middle rib can, however, also be slightly lower such that the middle ribs facing one another with a gap still separate the two chain links. The gap only has to be smaller than the diameter of the chain links to be connected for this.

The block connecting link according to the invention and a preferred method for mounting said lock will be explained in more detail in the following, with reference to the drawings, in which:

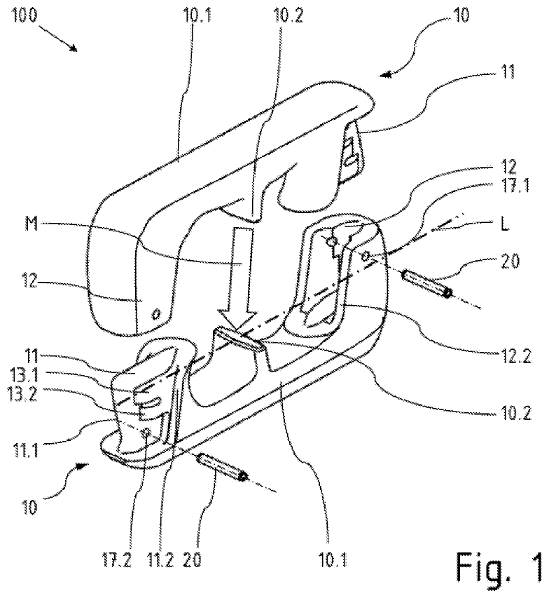

FIG. 1 is a detailed perspective view of a block connecting link according to the invention prior to mounting;

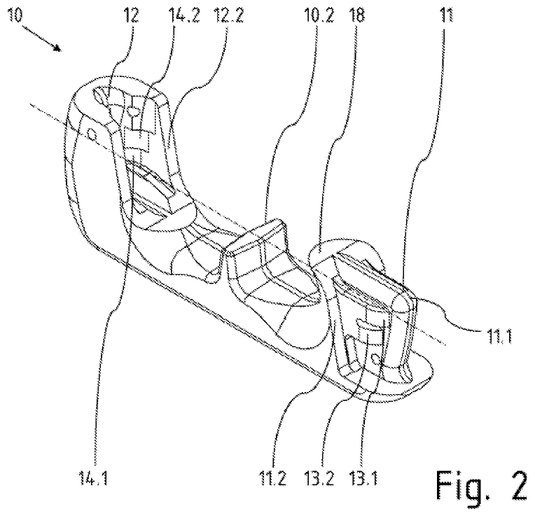

FIG. 2 is a detailed perspective view of a half element for a block connecting link;

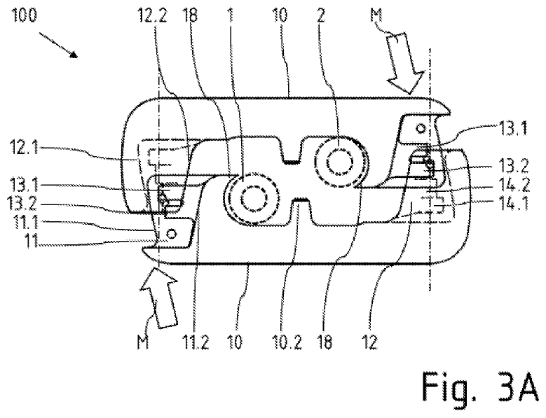

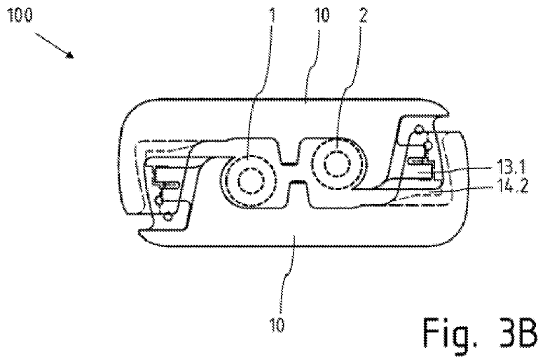

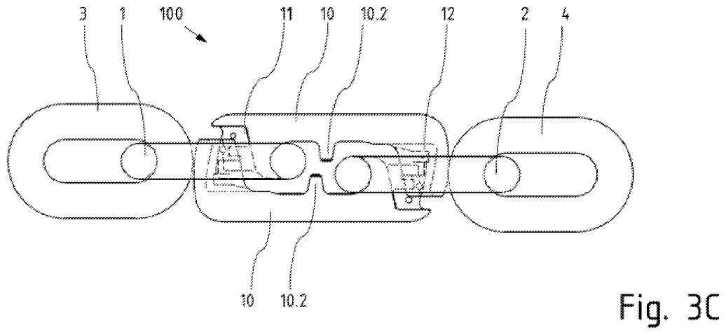

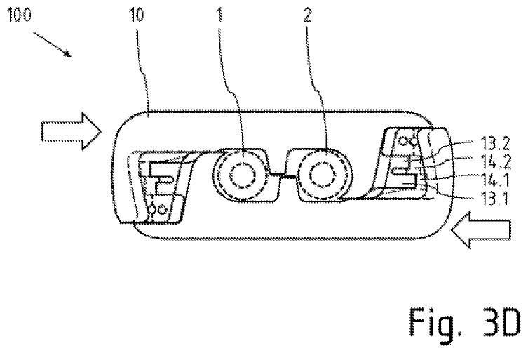

FIG. 3A-3D are detailed side views of the block connecting link in various mounting steps; and

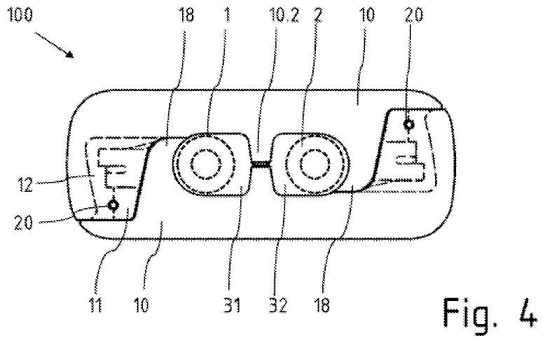

FIG. 4 is a detailed side view of the block connecting link once it has finished being put together.

FIG. 1 is an exploded perspective view of a block connecting link 100 formed of two half elements 10. The half elements 10 are preferably identical. The arrow between the half elements 10 denotes the mounting direction M, in which the top half element 10 is placed on the bottom half element 10 and the dot-dash line denotes the position of a longitudinal axis L.

Each half element 10 comprises a longitudinal rib 10.1, at one end of which an insertion pin 11 is formed, wherein the width thereof is considerably smaller compared with the other portions. Two retaining ribs 13.1, 13.2 having different lengths are formed on the lateral outer flanks of the insertion pin 11. The insertion pin 11 is delimited by a flank 11.2 that extends obliquely upwards, and specifically with an inclination towards the middle. By contrast, the end edge 11.1 of the insertion pin 11 extends obliquely outwards from the outer side towards a parting plane, which runs through the longitudinal axis L, in each case, such that the insertion pin 11 has a trapezoidal shape when viewed from the side.

A receiving pocket 12 is formed at the opposite end of the longitudinal rib 10.1 of the half element 10, which is likewise delimited by an oblique flank 12.2, wherein the inclination thereof corresponds to the inclination of the flank 11.2 on the insertion pin 11. Receiving pockets 12 and insertion pins 11 form complementary receiving portions; this means that receptacles and grooves on one side interact with projections and ribs on the respective mating part.

A middle rib 10.2 is formed between the insertion pin 11 and the receiving pocket 12 and protrudes transversely from the longitudinal rib 10.1. In addition, holes 17, 18 are provided, into which securing pins 20 can later be inserted after the half elements 10 have been assembled.

FIG. 2 is a perspective view of an individual half element 10 in order to show in particular the shape of the retaining ribs 13.1, 13.2 in the insertion pin 11 and the associated retaining grooves 14.1, 14.2 in the receiving pocket 12. Ribs 13.1, 13.2 and grooves 14.1, 14.2 have axially parallel top and bottom edges, which are used to transmit force, are rounded and each taper towards the end faces in order to facilitate the mounting process.

FIG. 3A is a side view of a first mounting step. A chain link 1 is inserted into a bottom half element 10 on the left and is interlockingly held on a hook-shaped projection 18. Another half element 10 is shown thereabove. This receives a second chain link 2 on the right, which is likewise already guided and held by means of a hook-shaped rib 18 in an earlier mounting stage. The vertically dashed lines denote the position of the particular edge in the receiving pocket 12, which the longer retaining rib 13.1 of the insertion pin 11 has to pass through at first. Since both the retaining grooves 14.1, 14.2 and the associated retaining ribs 13.1, 13.2 are rounded at their end faces, the starting position of the two half elements 10 shown in FIG. 3A with just a very small axial offset with respect to one another is possible. As a result, a very short closing path is formed, which can take place in full inside the particular eye of the connected chain link 1, 2. The block connecting link 100 therefore does not need to be swung around into the path of the chain.

FIG. 3B shows the next mounting step, in which the retaining elements are moved closer to one another such that the particular longer retaining ribs 13.1 are positioned at the level of the particular shorter retaining grooves 14.2.

FIG. 3C once again shows this mounting step together with the adjacent chain links 1, 2, 3, 4 in order to show that the path available for closing the block connecting link is delimited due to the length and shape of the chain links. The two half elements 10 together with their insertion pins 11 and receiving pockets 12 are already fully positioned inside the eyes of the adjacent chain links 1, 2 in this intermediate mounting step, wherein the chain links can remain in the stretched path of the chain and do not have to be displaced in order to mount the block connecting link.

In order to finally join the half elements 10, another last stepped movement is carried out proceeding from the position according to FIGS. 3B and 3C, in which the half elements 10 are firstly pushed against one another longitudinally with respect to the longitudinal extension of the chain strand, then pushed apart in order to re-release the temporary engagement of the long retaining ribs 13.1 in the short retaining grooves 13.2, and then pushed transversely such that the position according to FIG. 3D is achieved. From here, the half elements 10 are moved into the end position by a final advancement movement in the longitudinal direction.

The end position is shown in FIG. 4. The long retaining ribs and retaining grooves 14.1, 13.1 likewise engage in one another like the short retaining ribs and retaining grooves 14.2, 13.2. The middle ribs 10.2 rest against one another such that two eyes 31, 32 are formed that are separated from one another. The ends of the eyes 31, 32 are each formed by the inner flanks 18 that are rounded in the shape of hooks. The securing pins 20 inserted secure the position of the two half elements 10 with respect to one another.

1. A block connecting link (100) for round steel chains, comprising:
two half elements (10), which can be moved relative to one another in order to open and close the block connecting link (100), each of said half elements comprises ends that are interconnected by means of a longitudinal rib (10.1), one end of said ends comprises a insertion pin (11) having a smaller width than the longitudinal rib and retaining ribs (13.1, 13.2) that are integrally formed on either side, at least two parallel retaining ribs (13.1, 13.2) being arranged one on top of the other on either side, and the other end of said ends comprises a receiving pocket (12) for receiving the insertion pin (11), at least two retaining grooves (14.1, 14.2) formed one on top of the other on the two lateral inner flanks thereof in order to form teeth by receiving the retaining ribs (13.1, 13.2), characterized in that
a middle rib (10.2) extends inward from at least one longitudinal rib (10.1) to a longitudinal axis (L);
when viewed from the side, the insertion pin (11) widens from the longitudinal rib (10.1) towards its end and the length of the retaining ribs (13.1, 13.2) increases; and
when viewed from the side, the receiving pocket (12) tapers from the longitudinal rib (10.1) to its end and the length of the retaining grooves (14.1, 14.2) decreases.

2. The block connecting link (100) as set forth in claim 1, characterized in that the insertion pin (11) comprises two retaining ribs (7, 8) and the receiving pocket (12) comprises two retaining grooves (13, 14).

3. The block connecting link (100) as set forth in claim 2, characterized in that the retaining ribs (7, 8) and retaining grooves (14.1, 14.2) that are different lengths are arranged in the receiving regions formed by the insertion pins (11) and receiving pockets (12), wherein said receiving regions are trapezoidal when viewed in cross section, the insertion pin together with the outwardly projecting retaining ribs (7, 8) has the longer side in a parting plane and tapers towards the outer edge of the block connecting link, towards the longitudinal rib (10.1), and the receiving pockets (12), in the side flanks of which the retaining grooves (14.1, 14.2) are formed, have the narrow side in the parting plane in each case and widen outwards therefrom towards the longitudinal rib (10.1).

4. The block connecting link (100) as set forth in claim 1, characterized in that, when viewed from the side, the insertion pin (11) and the receiving pocket (12) of the half elements (10) are delimited by outer edges (11.1, 11.2) and flanks (11.2, 12.2) that are oriented obliquely with respect to the longitudinal axis (L).

5. The block connecting link (100) as per claim 4, characterized in that, when viewed from the side, the insertion pin (11) and the receiving pocket (12) of the half elements (10) are delimited by outer edges (11.1, 12.1) and flanks (11.2, 12.2), which are oriented at an angle of from 60° to 85° with respect to the longitudinal axis (L).

6. The block connecting link (100) as set forth in claim 1, characterized in that the insertion pin (11) and the receiving pocket (12) are each provided with a transverse hole (17.1, 17.2) for receiving a securing element (20).

7. The block connecting link (100) as set forth in claim 1, characterized in that the middle rib (10.2) on each half element (10) extends up to the central axis of the block connecting link in each case to such an extent that, once the half elements (10) have been assembled, a gapless middle rib is formed.

8. The block connecting link (100) as set forth in claim 1, characterized in that, after the half elements (10) have been assembled, a middle rib having a gap is formed.
